(19) United States
(12) Patent Application Publication
(10) Pub. No.: US 2010/0285320 A1
(43) Pub. Date: Nov. 11, 2010

(54) Amorphous thin films and method of manufacturing same

(76) Inventor: Mohammed Saad, Ile des Soeurs (CA)

Correspondence Address: Louis Tessier, C.P. 54029, Mount-Royal, QC, H3P 3H4, CA

(21) Appl. No.: 12/078,895

(22) Filed: Apr. 8, 2008

Related U.S. Application Data
(63) Continuation-in-part of application No. 10/515,824, filed on Nov. 26, 2004.

(51) Int. Cl. C09D 1/00; C03C 13/04; B32B 17/06; B32B 9/00

(52) U.S. Cl. 428/432; 501/37; 106/286.4; 428/696; 428/697

(57) ABSTRACT

The present invention relates to amorphous thin films and methods of manufacturing the same. These amorphous thin films contain zirconium oxide (ZrO₂), preferably at a concentration of at least 30 mol %, and other metal oxides and have surprisingly good mechanical and optical properties. In some embodiments of the present invention, the thin films may be further processed to obtain fluorinated glasses containing the same metal elements as the metal oxides.

The present application is a Continuation-in-Part of U.S. patent application Ser. No. 10/515,824 filed on Nov. 26, 2004.

### FIELD OF THE INVENTION

The present invention relates to materials for manufacturing optical elements. More specifically, the present invention is concerned with amorphous thin films and methods of manufacturing same.

### BACKGROUND

There is an increasing demand for small and cost effective passive and active optical elements and devices, such as planar waveguide circuits and integrated devices, optical amplifiers, lasers, attenuators, filters, and multiplexers, among others. Doped amorphous solids manufactured using a sol-gel method show promising physical characteristics for such applications.

However, these solids typically include a SiO₂ base which has numerous disadvantages. For example, it is relatively difficult to mix other metal oxides with SiO₂ in large proportions, which limits the range of optical properties that can be achieved using this material. Finally, SiO₂ absorbs light in the infrared region of the spectrum, which is disadvantageous in many applications.

While crystalline metal oxides having various compositions have been synthesized, the composition of these metal oxides is limited by the crystalline nature of these compositions of matter. Therefore, physical properties of these compositions of matter can only be varied over relatively small ranges.

Against this background, there exists a need in the industry to provide novel amorphous thin films and methods of manufacturing same. An object of the present invention is therefore to provide amorphous thin films and methods of manufacturing same.

### SUMMARY OF THE INVENTION

In a broad aspect, the invention provides an amorphous thin film comprising a first metal oxide and a second metal oxide, the first metal oxide being ZrO₂ present in a concentration of at least 30 mol %. In some embodiments of the invention, the second metal oxide is an oxide of a metal selected from the group consisting of hafnium, titanium, zinc, and cadmium. In alternative embodiments of the invention, the second metal oxide is an oxide of a metal selected from the group consisting of barium, strontium, lithium, sodium, potassium, aluminum, gallium, indium, silicon, scandium, yttrium, and lanthanum. In yet other embodiments of the invention, the second metal oxide is an oxide of a metal selected from the group consisting of a transition metal, a lanthanide, an actinide, and an element from one of the periodic table of the elements Groups Ia, IIa, IIIa, IVa, Va, IIb, IIIb, IVb, and Vb.

For example, the second metal oxide is a transition metal oxide present in a concentration of about 0.05 mol % to about 30 mol %. In another example, the second metal oxide is a rare earth metal oxide present in a concentration of about 0.01 mol % to about 30 mol %.

In yet another example, the amorphous thin film is essentially devoid of SiO₂. Such thin film are advantageously typically relatively transparent at mid infrared wavelengths.

In some embodiments of the invention, the amorphous thin film further comprises a third metal oxide, the third metal oxide being a photosensitive metal oxide. For example, the third metal oxide is selected from the group consisting of GeO₂, CeO₂, and SnO₂. More generally, the proposed amorphous thin films typically comprise from two to six different metal oxides. Also, in some embodiments of the invention, the metal oxides have been fluorinated.

In another broad aspect, the invention provides an optical element comprising an amorphous thin film as described hereinabove. For example, the amorphous thin film is deposited onto a substrate, the substrate being an amorphous material, such as, for example, an amorphous material selected from the group consisting of halide glasses, oxy-halide glasses, chalcogenide glasses, and Germanium oxide based glasses.

In another example, the amorphous thin film is deposited onto a substrate, the substrate being a crystalline material, such as, for example, a crystalline material selected from the group consisting of sapphire (Al2O3), ZnS, ZnSe, CaF₂, MgF₂, BaF₂ and Yttrium oxide (Y2O3).

In another broad aspect, the invention provides a method for preparing an amorphous thin film comprising the steps of:

(a) obtaining precursor compounds containing one or more selected constituent metal compounds, wherein each constituent metal compound comprises one or more metal elements and at least one metal element is Zr;

(b) preparing a solution by mixing the precursor compounds in a solvent;

(c) hydrolyzing the solution to obtained a hydrolyzed gel; and

(d) drying the hydrolyzed gel to obtain a dried gel forming an amorphous thin film.

The thin film is obtained when the hydrolyzed get is spread out over a suitably large area and left to dry.

Advantageously, the proposed method allows for manufacturing amorphous thin films having a large variety of compositions. In turn, this allows for manufacturing amorphous thin films having physical properties that vary over a relatively large range.

In addition, contrary to common beliefs in the related art, it was found that the proposed amorphous thin films can include many different metal oxides without negatively affecting the optical properties and stability of the amorphous thin film.

Examples of precursor compounds include C1-C4 alkoxides of the metal elements dissolved in an alcoholic solution. Other examples of precursors compounds include precursor compounds selected from the group consisting of C1-C4 alkoxides of one or more of the metal elements dissolved in an alcoholic solution, salts of one or more of the metal elements dissolved in one of an aqueous, alcoholic, or acidic solution, and mixtures thereof. Yet other examples of precursors compounds include precursor compounds selected from the group consisting of C1-C4 alkoxides of one or more of the metal elements dissolved in an alcoholic solution, acetates of one or more of the metal elements dissolved in an alcoholic solution, and mixtures thereof.

In some embodiments of the invention, hydrolyzing the solution comprises performing acidic hydrolysis and condensation at a temperature of about 35° C. to about 75° C. for about 30 minutes to about 90 minutes.

In some embodiments of the invention, the method further comprises the step of (e) treating the dried gel with a fluorinating agent in a vapor phase, wherein the fluorinating agent is selected from the group consisting of HF, F2, NF3 and SF6. For example, this step is performed at a temperature of about 150° C. to about 250° C.

In some embodiments of the invention, the hydrolyzed gel is dried, at least in part, at a temperature ranging from about 60° C. to about 800° C. for about 30 minutes to about 2 hours.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

FIG. 1 is a flowchart of a method for manufacturing an amorphous thin film in accordance with an embodiment of the present invention.

### DETAILED DESCRIPTION

Generally, the present invention relates to heavy metal oxide amorphous thin films, methods of manufacturing such thin films and optical elements including these thin films, such as for example waveguides, protective coatings, antireflection coatings and optical fiber preforms, among other possibilities. The thin films of the present invention contain zirconium oxide (ZrO₂), preferably at a concentration of at least 30 mol %, and have surprisingly good mechanical and optical properties. In some embodiments, the thin films may be further processed to obtain fluorinated glasses containing the same metals as the metal oxides used to produce the thin films.

The amorphous thin films of the present invention include at least two metal oxides, one of which is ZrO₂. In some embodiments of the invention, the amorphous thin film includes 2, 3, 4, 5, or 6 metal oxides. The stability of the amorphous thin films of the present invention is unexpected as it is widely believed that synthesizing amorphous materials including many different metal oxides is very hard or impossible. It was found that the use of ZrO₂ as a “base” material in the present amorphous thin films contributed to this surprising result.

In addition to ZrO₂, the present metal oxide thin films can include many other metal oxides, such as for example oxides of Hafnium, Titanium, Zinc, Cadmium, Barium, Strontium, Lithium, Sodium, Potassium, Aluminum, Gallium, Indium, Scandium, Yttrium, and Lanthanum. More generally, these thin films can include oxides of a metal selected from the group consisting of a transition metal, a lanthanide, an actinide, and an element from one of the periodic table of the elements Groups Ia, IIa, IIIa, IVa, Va, IIb, IIIb, IVb, and Vb, and mixtures thereof.

In some embodiments of the invention in which a transition element oxide is included in the thin film, it was found advantageous to include the transition element in a concentration of at least about 0.05 mol %. In some embodiments of the invention in which a rare earth oxide is included in the thin film, it was found advantageous to include the rare earth oxide in a concentration of at least about 0.10 mol %. These thin films selectively absorb predetermined optical wavelengths, the exact wavelength depending on the specific transition element or rare earth element used in a manner that is well-known in the art.

In some embodiments of the invention, the amorphous thin film may be essentially devoid of SiO₂. For the purpose of this specification, essentially devoid means present in a concentration that does not lead to a significant absorption in the mid infrared region of the spectrum. This concentration is typically below 10 parts per million (ppm) molar. Such thin films have relatively large transmission windows, especially in the mid infrared region of the spectrum. However, in alternative embodiments of the invention, the proposed amorphous thin film may include SiO₂.

In certain particularly advantageous embodiments of the invention, the amorphous thin films include ZrO₂, BaO, and a third metal oxide selected from the group consisting of GeO₂, CeO₂, and SnO₂.

In embodiments of the invention in which the amorphous thin film is part of an optical element, the amorphous thin film is typically deposited onto a substrate. Suitable substrates include an amorphous material, such as for example and non-limitingly, halide glasses, oxy-halide glasses, chalcogenide glasses, Germanium oxide based glasses; and crystalline materials such as sapphire (Al₂O₃), ZnS, ZnSe, BaF₂, MgF₂, CaF₂ and yttrium oxide (Y₂O₃).

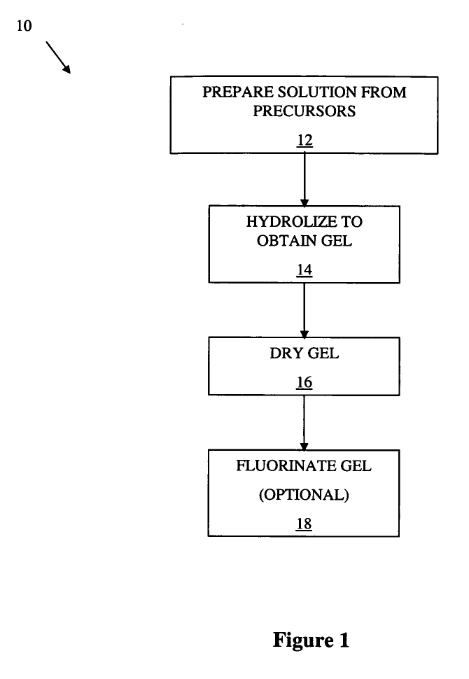

Typically, the thin films according to the invention may be obtained by a Sol-Gel process. FIG. 1 illustrates a method 10 for synthesizing an amorphous thin film including constituent metal compounds, each constituent metal compound including a metal, one of the metals being Zr. For example, the thin films thereby synthesized are heavy metal oxide thin films.

Broadly, the method 10 starts by preparing at step 12 a solution from conventional precursors containing all of the metals included in the constituent metal compounds, such precursors being well known in the art and, in many examples of implementation, readily commercially available. Then, at step 14, the method 10 includes hydrolyzing the solution to obtain a wet hydrolyzed gel. Subsequently, at step 16, the hydrolyzed gel is dried to obtain a dried gel. In some embodiments of the invention, the method continues at step 18 by treating the dried gel with a fluorinating agent in a vapor phase. This fluorinating step may occur at a temperature of about 150° C. to about 250° C. In certain embodiments, the fluorinating agent may be hydrogen fluoride, gaseous fluorine, NF₃ and SF₆, among other possibilities, and is flowed over the dried thin film. However, in alternative embodiments of the invention, the method does not include step 18.

There are many compounds that are usable at step 12. For example, in some embodiments of the invention, the precursors employed for preparing the wet oxygenated gel are C1-C4 alkoxides of metals included in constituent metal compounds dissolved in an alcoholic solution. In other embodiments, the precursors employed for preparing the wet oxygenated gel include C1-C4 alkoxides of some of the metals included in the constituent metal compounds dissolved in an alcoholic solution and salts of other metals included in the constituent metal compounds, the salts being dissolved in an aqueous, alcoholic or acidic solution. In yet other embodiments, these precursors include C1-C4 alkoxides of some of the metals included in the constituent metal compounds dissolved in an alcoholic solution and acetates of other metals included in the constituent metal compounds dissolved in an alcoholic solution. Typically, metal compounds which have a concentration lower than 20 mol % are added as salts (for example, chloride, acetate, oxalate, carbonate, and nitrate, among other possibilities) if such salts exist and are suitably soluble.

More specifically, examples of suitable precursors include methoxides, carbonates, oxalates, chlorides, and nitrates of the metals included in the constituent metal compounds. Also, suitable solvents in which the precursors are dissolved include C1-C4 aliphatic alcohols or mixtures of C1-C4 aliphatic alcohols, among other possibilities

At step 14, hydrolyzing the wet oxygenated gel to obtain a hydrolyzed gel is typically performed with an acid selected from the group consisting of acetic acid, hydrochloric acid, nitric acid, and mixtures thereof, among other possibilities. For example, the acid may be added to the hydrolyzed gel and mixed therewith at a temperature of about 35° C. to about 75° C. for about 30 minutes to about 90 minutes.

At step 16, drying is typically performed at room temperature or at a temperature ranging from about 60° to about 800° C. The drying step may be performed for about 30 minutes to about 2 hours. In alternative embodiments of the invention, drying is performed in two stages by first drying the gel at room temperature, and then drying at a temperature ranging from about 60° to about 500° C. for about 30 minutes to about 2 hours in an inert or reactive atmosphere (for example in O₂, N₂, Ar, or mixtures thereof, among other possibilities).

The exact parameters used when performing the method 10 depend on the exact composition of the dried gel to synthesize. Basic experimentation using well-known methods will allow the reader skilled in the art to determine these parameters.

When photosensitive ions are added to the starting solution to prepare the gel, a waveguide inscribed in a thin film prepared according to the present invention will be directly writable in the dried thin film using a laser beam.

The present invention further provides a method for making rare-earth doped optical fibers which includes mixing the zirconium based gel obtained with the method 10, which contain 0.5 to 10 mol % of rare-earth element, with a silica gel in the proportion 1 to 30 mol % of gel of zirconium based gel doped with rare earth elements, and 99 to 70 mol % of silica gel. Then, some layers of the mixed gel may be deposited directly on the inner part of a silica tube, or on porous soot already deposited on the inner part of the silica tube, at room temperature. Subsequently, drying the deposited layer under oxygen at a temperature ranging from about 500° C. to about 800° C. for 1 to 2 hours is performed, followed by dehydrating the core layer of the tube at a temperature ranging from about 600° C. to about 800° C. for 1 hour. Afterwards, sintering of the core layer is performed at a temperature ranging from about 1500° C. to about 1800° C. Finally, collapsing the tube in a conventional manner used in silica fiber technology provides an optical fiber preform. The doped optical fiber is obtained by drawing this preform.

### Example 1

A binary gel was obtained using the above-described methods by mixing a 70 mol % solution of Zirconium iso-propoxide in iso-propanol and a 20 mol % solution of Barium methoxide in methanol in quantities sufficient to obtain the following relative molar proportions of cations: 50 mol % Zr, and 50 mol % Ba. The solution was heated at 60° C. for 30 minutes and then hydrolyzed with a 5 mol % acetic acid aqueous solution. The quantity of acetic acid used was such that there was twice as many moles of acetic acid added in the solution as there were moles of Zr in the solution. Stirring was maintained for 30 additional minutes at the same temperature. After cooling, the solution was poured into a container and dried to obtain a stable dried gel by leaving the gel in ambient air for 2 days at room temperature.

### Example 2

A ternary stable gel was obtained by using Zirconium iso-propoxide (70 mol % in iso-propanol), Barium ethoxide (20 mol % in ethanol) and Aluminum methoxide in iso-propanol in quantities sufficient to obtain the following relative molar proportions of cations: 60 mol % Zr, 30 mol % Ba, and 10 mol % Al. The mixture was heated up to 60° C. for 45 minutes and then hydrolyzed with a 5 mol % acetic acid aqueous solution. The quantity of acetic acid used was such that there was twice as many moles of acetic acid added in the solution as there were moles of Zr in the solution. Stirring was maintained for 40 minutes at the same temperature. After cooling, the solution was poured into a container. A wet stable gel was obtained after 2 days, similarly to example 1.

### Example 3

A wet oxide gel was obtained by mixing Zirconium methoxide (70 mol % in methanol), Barium methoxide (20 mol % in methanol), Sodium methoxide in methanol, Aluminum methoxide and Lanthanum acetate in quantities sufficient to obtain the following relative molar proportions of cations: 50 mol % Zr, 20 mol % Ba, and 20 mol % Na, 5 mol % La, and 5 mol % Al. The mixture was heated up to 50° C. for 30 minutes and then hydrolyzed with an acetic acid solution as in examples 1 and 2 (with quantity of acetic acid such that there was twice as many moles of acetic acid added in the solution as there were moles of Zr in the solution). Stirring was maintained for 30 minutes at the same temperature. After cooling and drying for 30 minutes at room temperature, a stable and transparent gel was obtained.

### Example 4

Many different gels having the following relative molar compositions were prepared in a similar manner as the gels of Example 1:

A: 53 mol % Zr; 20 mol % Ba; 20 mol % Na, 3 mol % Al; 4 mol % La;

B: 53 mol % Zr; 20 mol % Ba; 20 mol % Na 5 mol %; 7 mol % Er;

C: 55 mol % Zr; 30 mol % Ba; 10 mol % Na; 5 mol % Pr;

D: 55 mol % Zr; 30 mol % Ba; 10 mol % Na; 5 mol % Tm;

E: 55 mol % Zr; 30 mol % Ba; 10 mol % Na; 5 mol % Cu;

F: 55 mol % Zr; 30 mol % Ba; 10 mol % Na; 5 mol % Fe;

G: 70 mol % Zr; 30 mol % Fe;

H: 85 mol % Zr; 15 mol % Pr;

In all of the examples described herein, the precursors were mixed and heated at 60° C. for 30 minutes and then hydrolyzed with an aqueous acetic acid solution. The solutions were then poured into a container to obtain a dried gel. The dried gel was in all cases stable and optically transparent.

Stable and transparent thin films can be obtained from wet oxide gels according to examples 1-4, and more generally using amorphous gels in accordance with the invention after hydrolysis and condensation steps, to obtain appropriate viscosity, by conventional spin coating or dip coating techniques.

Although the present invention has been described hereinabove by way of preferred embodiments thereof, it can be modified, without departing from the spirit and nature of the subject invention as defined in the appended claims.

What is claimed is:

1. An amorphous thin film comprising a first metal oxide and a second metal oxide, said first metal oxide being ZrO₂ present in a concentration of at least 30 mol %.

2. The amorphous thin film of claim 1, wherein said second metal oxide is an oxide of a metal selected from the group consisting of hafnium, titanium, zinc, and cadmium.

3. The amorphous thin film of claim 1, wherein said second metal oxide is an oxide of a metal selected from the group consisting of barium, strontium, lithium, sodium, potassium, aluminum, gallium, indium, silicon, scandium, yttrium, and lanthanum.

4. The amorphous thin film of claim 1, wherein said second metal oxide is an oxide of a metal selected from the group consisting of a transition metal, a lanthanide, an actinide, and an element from one of the periodic table of the elements Groups Ia, IIa, IIIa, IVa, Va, IIb, IIIb, IVb, and Vb.

5. The amorphous thin film of claim 1, wherein said second metal oxide is a transition metal oxide present in a concentration of about 0.05 mol % to about 30 mol %.

6. The amorphous thin film of claim 1, wherein said second metal oxide is a rare earth metal oxide present in a concentration of about 0.01 mol % to about 30 mol %.

7. The amorphous thin film of claim 1, wherein said amorphous thin film is essentially devoid of SiO₂.

8. The amorphous thin film of claim 1, further comprising a third metal oxide, said third metal oxide being a photosensitive metal oxide.

9. The amorphous thin film of claim 8, wherein said third metal oxide is selected from the group consisting of GeO₂, CeO₂, and SnO₂.

10. The amorphous thin film of claim 1, wherein said amorphous thin film comprises from two to six different metal oxides.

11. The amorphous thin film of claim 1, wherein said first and second metal oxides have been fluorinated.

12. An optical element comprising the amorphous thin film of claim 1.

13. The optical element of claim 12, wherein said amorphous thin film is deposited onto a substrate, said substrate being an amorphous material.

14. The optical element of claim 13, wherein said amorphous material is selected from the group consisting of halide glasses, oxy-halide glasses, chalcogenide glasses, and Germanium oxide based glasses.

15. The optical element of claim 12, wherein said amorphous thin film is deposited onto a substrate, said substrate being a crystalline material.

16. The optical element of claim 15, wherein said cristaline material is selected from the group consisting of sapphire (Al₂O₃), ZnS, ZnSe, CaF₂, MgF₂, BaF₂ and Yttrium oxide (Y₂O₃).

17. A method for preparing an amorphous thin film comprising the steps of:
(a) obtaining precursor compounds containing one or more selected constituent metal compounds, wherein each constituent metal compound comprises one or more metal elements and at least one metal element is Zr;
(b) preparing a solution by mixing the precursor compounds in a solvent;
(c) hydrolyzing the solution to obtained a hydrolyzed gel; and
(d) drying the hydrolyzed gel to obtain a dried gel forming an amorphous thin film.

18. The method of claim 17, wherein the precursor compounds are C1-C4 alkoxides of the metal elements dissolved in an alcoholic solution.

19. The method of claim 17, wherein the precursor compounds are selected from the group consisting of C1-C4 alkoxides of one or more of the metal elements dissolved in an alcoholic solution, salts of one or more of the metal elements dissolved in one of an aqueous, alcoholic, or acidic solution, and mixtures thereof.

20. The method of claim 17, wherein the precursor compounds are selected from the group consisting of C1-C4 alkoxides of one or more of the metal elements dissolved in an alcoholic solution, acetates of one or more of the metal elements dissolved in an alcoholic solution, and mixtures thereof.

21. The method of claim 17, wherein hydrolyzing the solution comprises performing acidic hydrolysis and condensation at a temperature of about 35° C. to about 75° C. for about 30 minutes to about 90 minutes.

22. The method of claim 17, further comprising the step of (e) treating the dried gel with a fluorinating agent in a vapor phase, wherein the fluorinating agent is selected from the group consisting of HF, F₂, NF₃ and SF₆.

23. The method of claim 22, wherein treating the dried gel with a fluorinating agent in a vapor phase is performed at a temperature of about 150° C. to about 250° C.

24. The method of claim 17, wherein the hydrolyzed gel is dried at a temperature ranging from about 60° C. to about 800° C. for about 30 minutes to about 2 hours.
